(19) United States
(12) Patent Application Publication
(10) Pub. No.: US 2022/0039392 A1
(43) Pub. Date: Feb. 10, 2022

(54) Antiviral Antimicrobial Article

(71) Applicant: James F. Dempsey, North Olmsted, OH (US)

(72) Inventor: James F. Dempsey, North Olmsted, OH (US)

(21) Appl. No.: 17/392,833

(22) Filed: Aug. 3, 2021

Related U.S. Application Data
(60) Provisional application No. 62/706,164, filed on Aug. 4, 2020.

(51) Int. Cl. A01N 59/20; A01N 59/16; A01N 25/34; A63B 21/00; A43B 17/00

(52) U.S. Cl. CPC A01N 59/20; A01N 59/16; A01P 1/00; A63B 21/4037; A43B 17/003; A01N 25/34

(57) ABSTRACT

An article used in a fitness activity such as the practice of yoga that may be exposed to a corona virus, such as COVID-19, the article including a substrate having at least one contact surface, wherein the substrate includes an antiviral material in an effective amount to reduce the life span of the virus, wherein the antiviral material is at least partially exposed on the contact surface of the substrate.

### TECHNICAL FIELD

In general, the following disclosure relates to an antiviral antimicrobial article used in fitness activities. More particularly, the disclosure relates to an article that includes an antiviral material in an effective amount to reduce the life span of any virus or other microbes such as bacteria or fungus that comes in contact with the article. Most particularly, the disclosure relates to an article used in fitness activities such as yoga having at least one contact surface containing antiviral material in an effective amount to provide an antiviral or antimicrobial effect to the contact surface, also known as self-sanitizing and/or self-sterilizing surface.

### SUMMARY

The present disclosure generally relates to an antiviral article used in the practice of yoga that may be exposed to a virus, the article including a substrate having at least one contact surface, wherein the substrate includes copper content in an effective amount to reduce the life span of the virus, bacteria and/or fungus.

The present disclosure further relates to an antiviral article used in the practice of yoga that may be exposed to a virus, the article including a substrate having at least one contact surface, the substrate including at least one of a film containing antiviral metal, a coating containing antiviral metal, and a fiber having antiviral metal thereon; wherein the antiviral particles are at least one of a copper particle, a copper powder, and ionic forms thereof; the substrate containing an effective amount of antiviral metal to reduce the lifespan of the virus, bacteria and/or fungus on the contact surface.

A process for producing an antiviral yoga article according to the above examples comprising providing a substrate, adding an effective amount of antiviral metal to the substrate; and forming the substrate containing the effective amount of antiviral material into a yoga article.

### DESCRIPTION OF THE DRAWINGS

FIG. 1 is a partially schematic view of an antiviral article according to an example.

FIG. 2 is a partially schematic view of an antiviral article according to an example.

FIG. 3 is a partially schematic view of an antiviral article according to an example.

FIG. 4 is a partially schematic view of an antiviral article according to an example.

FIG. 5 is a side view of an antiviral article according to an example depicting further details of an antiviral material incorporated within the article.

FIG. 6 is a top view of an antiviral article according to an example depicting further details of an antiviral material incorporated within the article.

FIG. 7 is a side view of a portion of an antiviral article enlarged to show details of fibers incorporating antiviral metal attached to a substrate of the article.

FIG. 8 is a partially schematic view of an antiviral article constructed from fibers incorporating antiviral metal.

FIG. 9 is a partially schematic view of an antiviral article with a sheath cut away on one side to show details of a substrate of the article with a sheet containing antiviral metal attached to the outer surface of the substrate.

FIG. 10 is a diagram of a process for forming an antiviral article according to an example.

FIG. 11 is a diagram of a process for forming an antiviral article according to an example.

FIG. 12 is a diagram of a process for forming an antiviral article according to an example.

FIG. 13 is a diagram of a process for forming an antiviral article according to an example.

FIG. 14 is a partially schematic top view of an antiviral matrix according to an example.

FIG. 15 is a side view of a polymer fiber infused with an antiviral metal particle.

FIG. 16 is a perspective view of an antiviral article in the form of an insert for a shoe or other form of footwear.

FIG. 17 is a perspective view showing an example of fitness equipment incorporating an antiviral article on high touch surfaces.

In the accompanying drawings which are incorporated in and constitute a part of the specification, embodiments of the invention are illustrated, which, together with a general description of the invention given above, and the detailed description given below, serve to example the principles of the invention.

### DETAILED DESCRIPTION

With the advent of COVID-19 Coronavirus the need for antiviral technologies for high-touch surfaces is increasingly important. In the practice of yoga, a yogi's hands, feet and other portions of the skin are often in contact with a surface of the articles used in the practice of yoga. Moreover, the user's exertion often causes them to sweat onto the yoga articles. In addition, yoga poses cause the user to face the article making it possible for fluid particles containing virus to be exhaled from the mouth or nose onto the article or nearby yoga mats of other practicing yogis. Other high touch articles used in fitness and wellness exercise including but not limited to padding on fitness equipment or inserts for shoes are subject to the same conditions and exhibit the same need for antiviral technology.

Typical articles used in the practice of yoga and other forms of exercise include but are not limited to padding, a yoga mat, a yoga block, a yoga strap and a yoga blanket. Padding may include cushions, bolsters or mats common in yoga practice or those inserted into shoes, or provided on the grips, seats and other high touch areas on fitness equipment, wrestling and exercise mats. Presently, these articles may be treated with chemical compounds, such as household cleaners, bleaches, hydrogen peroxides to attempt to remove viruses, reduce virus lifespan on the surface or kill the virus. Often these chemicals have deleterious health effects and can degrade the materials over time. This may be compounded when frequent applications of the chemicals are required, for example, when the article is used by an instructor that teaches several classes a day or a dedicated yogi that practices yoga on a repeated basis throughout each week. Such effects are at odds with the goal of promoting wellness through the practice of yoga and physical fitness. Therefore, there is a great need for an antiviral article used in yoga practice and/or physical fitness that can reduce or eliminate the need for such chemical applications.

To that end, the following examples discuss providing an antiviral material, i.e. one that is effective in reducing the life span of a virus and inactivating pathogens, within or on articles used in fitness activities including but not limited to yoga. While non-metal antiviral materials may be used, elemental copper (Cu) is a natural antiviral material that is also associated with health and wellness benefits. Other metals with antiviral properties include silver, zinc, gold and platinum. Alloys of these metals and ionic forms including but not limited to metal salts have similar antiviral properties. In this disclosure, these materials will be collectively referred to as an “antiviral metal.” These antiviral metals are also known to have antibacterial, antimicrobial, antifungal and other related beneficial effects. It will be understood that the reference to antiviral effect or antiviral metal herein is not limited to the ability to shorten the life span of a virus and includes the antibacterial, antimicrobial, antifungal and related effects of these metals. It is expected that the effective amounts described in connection with the ability to reduce the lifespan of a virus in the disclosure also are effective in producing antibacterial, antimicrobial, antifungal and related effects.

BiaXam™ by Kraton, a unique polymeric material, described in U.S. Patent Application Publication 2020/0154701, which is incorporated herein by reference, has been found effective as an anti-viral material effective in reducing the lifespan of viruses included Covid 19. BiaXam™ may be provided as an anti-viral material in film form or as a polymer additive that may be applied to or incorporated in an article as described in the examples below. BiaXam™ is a sulfonated block copolymer. The sulfonated polymer may be a sulfonated polyester, formed by directly sulfonating a polyester resin in any form, e.g., fiber, yarn, woven fabric, film, sheet, and the like, with a sulfuric anhydride-containing gas containing sulfuric anhydride, for a concentration of the sulfone group on the surface of the polyester ranging from 0.1 meq/g to above 3 meq/g, e.g., up to 5 meq/g, or at least 6 meq/g. Alternatively, the sulfonated polymer is a selectively sulfonated negative charged anionic block copolymer. For example, a selectively sulfonated copolymer may include .0 sulfonic acid as well as neutralized sulfonate derivatives. The sulfonate group can be in the form of metal salt, ammonium salt or amine salt. This material provides antimicrobial protection and has been found effective to kill up to 99.999% of the SARS-CoV-2 virus under laboratory conditions. Other non-metallic antiviral materials may also be used to form or applied to an article 100 as described herein.

According to the examples an effective amount of an antiviral material is provided on or within an article used in a fitness activity such as the practice of yoga to create an antiviral effect. Such articles typically have at least one contact surface i.e. a surface that contacts the user's skin or clothing, or is exposed to sweat or breath. In examples described herein, the antiviral material may be disbursed within the article to provide an antiviral property on the contact surface or the contact surface may be formed with an antiviral material therein. It will be understood that the article may be used for other fitness and exercise activities or as a pad or cushion for other activities. Therefore, the intended use of the articles described herein should not be considered limiting. An antiviral article containing an effective amount of antiviral material may be constructed for use as exercise and wrestling mats, knee pad, mechanic's pad and the like among other examples. Other configurations described herein such as blocks, straps and blankets may similarly be applied in other high touch applications including but not limited to exercise straps, steps, handles and grips for exercise equipment and the like.

Using copper as an example of an antiviral material, it has been found that an effective amount of copper, copper ion or copper salts at least partially exposed on the contact surface greatly reduces the life span of a virus on that surface. In particular, it has been found that copper in its elemental form or in ion form works to disrupt the membrane of viruses that come in contact with the copper including the COVID-19 Coronavirus. In this way, the lifespan of the virus is reduced because the disruption of the membrane causes the virus cells to die. While the lifespan of COVID-19 on an article has not been determined with certainty, studies of similar surfaces such as polymer surfaces and fabrics suggest that the uninterrupted life span of the virus on such surfaces ranges from 6-48 hours. Such extended periods of time present the opportunity for anyone coming in contact with these surfaces to pick up the virus and risk infection. Any reduction in the lifespan of the virus on such surfaces will assist in reducing the transmission of the virus.

Studies have shown that contact between the COVID-19 virus and copper particles reduce the lifespan of the virus according to the mechanism described above. The disruption of the cell membrane often leads to reducing the lifespan of the virus from hours to minutes. Copper materials include copper containing alloys, elemental copper, copper oxide or cuprous oxide, and copper ions including Cu++ have been found effective in amounts from 0.25% by weight and greater. Other studies have shown that increasing the concentration of copper further decreases the life span of a virus including COVID-19. Therefore, greater concentrations of copper by weight are effective in killing the virus in a shorter time.

Similar studies have shown that similar effective amounts of antiviral metal produce antibacterial, antimicrobial, antifungal and related effects, and therefore, use of the term antiviral is not limiting in the disclosure. Examples showing these effects are found in U.S. Pat. Nos. 7,169,402; 9,439,437 and 10,501,587 and U.S. Pat. Pubs. 2007/243263 and 2020/154701 incorporated herein by reference. For sake of brevity, use of the term “antiviral” will be used to collectively refer to antiviral, antibacterial, antimicrobial, antifungal and related effects. Likewise, use of “antiviral metal” will be understood as a metal that is capable of producing at least one of an antiviral, antibacterial, antimicrobial, antifungal effect. And an “antiviral article” will be understood as an article that contains an effective amount of antiviral material to produce at least one of an antiviral, antibacterial, antimicrobial, and antifungal effect.

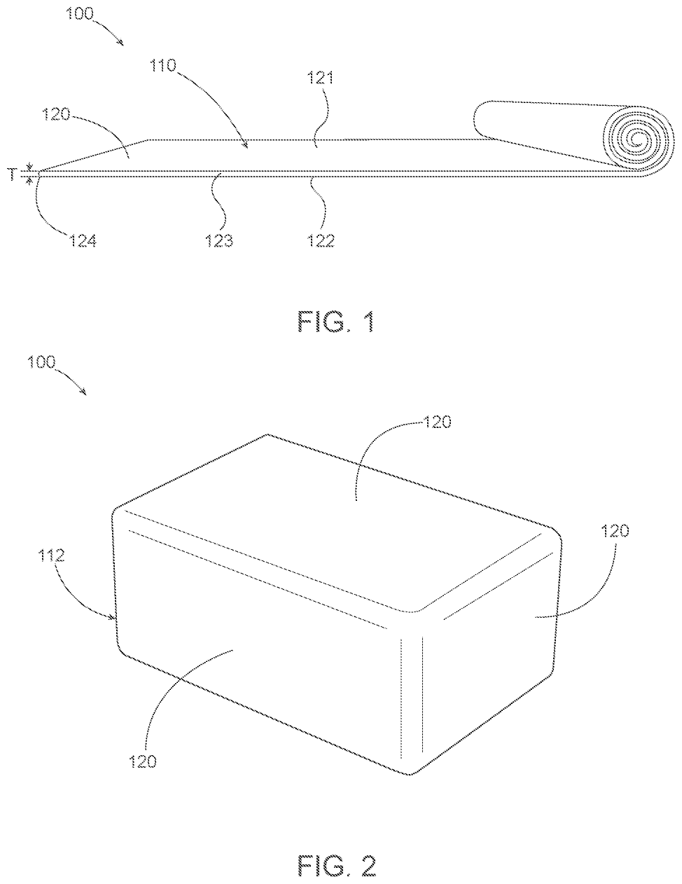

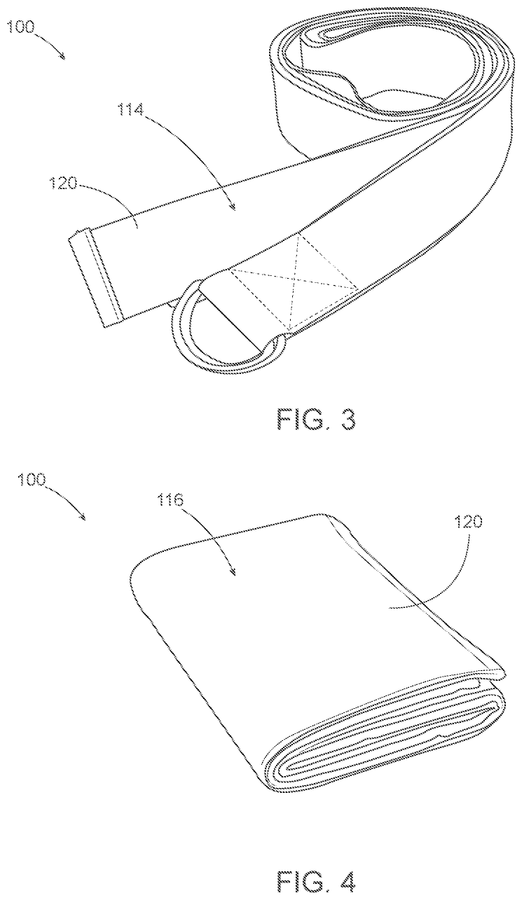

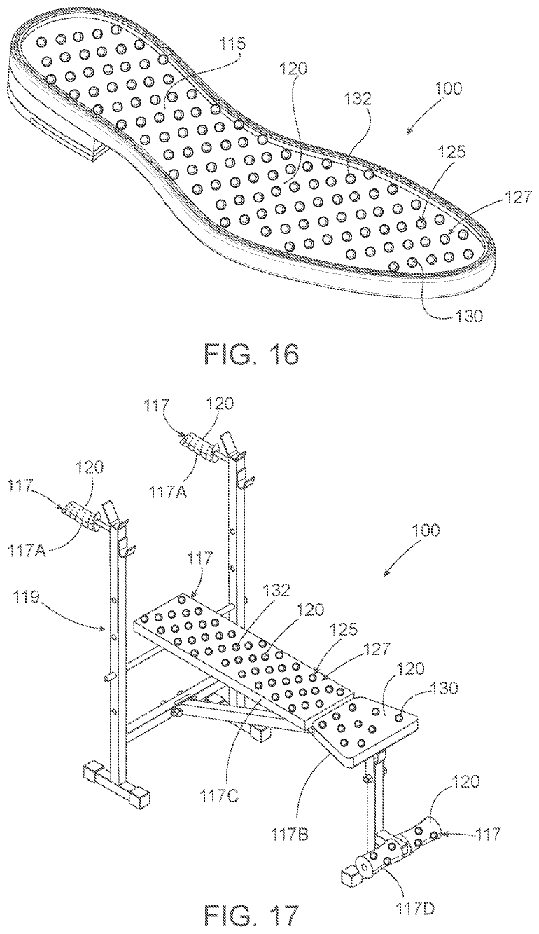

According to the disclosure, an article used in physical fitness and/or the practice of yoga is generally indicated by the number 100. Article 100 may include a yoga mat 110 (FIG. 1), a yoga block 112 (FIG. 2), a yoga strap 114 (FIG. 3), a yoga blanket 116 (FIG. 4), or padding used on a shoe insert (FIG. 16) or on fitness equipment (FIG. 17). Article 100 includes at least one contact surface 120. A contact surface 120 is any surface that comes in contact with a user. The contact surface 120 is generally an outer surface of the article 100. It will be understood that some contact surfaces receive greater contact than others as a function of the article's use. For example, considering a rectangular yoga mat 110 (FIG. 1), the outer surface comprises a first surface 121 and second surface 122 that are made to lie on a supporting surface and provide an area on which the user performs their yoga practice, which typically includes assuming various poses, postures and positions on the mat and holding those poses. The thickness T of the mat, creates two elongate side surfaces 123 and two ends 124 that are not used during the practice, but are contacted by the user when handling the mat 110. The thickness T of the mat 110 may vary but is generally much less than the width of the first and second surfaces 121,122.

In general, the first and second surfaces 121,122, which may also be referred to as the top and bottom surface, have larger surface areas and are designed to support the user's weight. When spread onto a supporting surface, one of the first and second surfaces is placed on the supporting surface becoming the bottom surface and the opposite surface faces upward to become a top surface. In some examples, the first and second surfaces will both have an effective amount of antiviral material 125 such that both surfaces will have an antiviral effect. In other examples, only one of the first and second surfaces 121,122 will have an antiviral property such that it would typically be the top surface during practice. While the first and second surfaces are subjected to the greatest amount of contact, the sides and ends may be contacted when handling the mat 110. Therefore in other examples, all of the outer surfaces may be provided with an effective amount of antiviral material 125.

With reference to FIG. 2, A yoga block 112 is typically a rectangular solid with 6 sides. The particular shape shown in he figures is not limiting. Yoga blocks may be provided in other shapes to assist in lengthening, maintaining poses, and facilitating alignment. For example, egg shaped, ring shaped, and wedge-shaped blocks are also commonly used in yoga practice. Each of the outer surfaces of the block 112 is typically contacted by the hands of the user during various poses and may be used to support other portions of the user's body as well. The block 112 may be made of a single solid material such as a polymer foam, cork or wood. Since the user may rest a large portion of their body weight on the block 112, yoga blocks are made of fairly dense polymer foam and other substantially rigid material. According to an example, block 112 may have a solid core with an outer layer, sheath or cover to allow combinations of material as discussed more completely below.

As shown in FIG. 3, a strap 114 is an elongate rectangular flexible member that is looped around a body part such as foot or shin with the ends of the strap 114 grasped in the user's hands. With the rectangular shape of strap 114, it includes generally six sides including wider first and second surfaces and sides and ends created by the thickness of the strap 114. Since the user may grasp any portion of the strap 114 during practice, the outer surface is a contact surface 120

With reference to FIG. 4, yoga blanket 116 typically is a rectangular blanket that may be folded or bunched to provide support during poses or act as a cushion. The outer surface is similar to a mat in that it includes two larger area first and second surfaces and very thin sides. As in the case of mat 110, one or more of the outer surfaces may be a contact surface 120. As in the examples above, antiviral material 125 may be applied to the one or more contact surfaces 120 to provide an antiviral effect to the blanket 116.

As described above, article 100, in general, is a high touch article and the contact surfaces must be made to be in regular contact with the user's body. Often the article 100 is in contact with bare skin and used when the user is performing a vigorous activity. As described above, at least one of the surfaces of these articles 100 may be treated with an antiviral material 125 as described more completely below.

Focusing on the yoga mat 110 as an example of an article 100, the user's hands and feet are in regular contact with a contact surface 120 of the yoga mat 110 during practice. The practice of yoga includes poses where the user's hands and or feet are in static contact with the surface and also transitional movements where the hands and feet are leaving and re-contacting the yoga mat 110. In some instances, the contact is impactful as at least a portion of the weight of the user lands on contact surface 120. To that end, construction of a yoga mat 110 according to the disclosure accounts for the practice of yoga on the mat including attention to the cushioning function of the mat, the need for adequate grip to maintain poses, the tolerance of sweat or other moisture during practice and the ability to reuse the mat. These considerations are also effective in the context of other fitness equipment. As discussed above, providing an antiviral contact surface on an article 100 that reduces or eliminates the need for disinfecting with chemical cleaners greatly improves the life of the article 100 and also is important to the well-being of the user by reducing the skin contact with such chemicals or inhaling of chemical vapors or odors created by the reactions of the chemicals with the contact surface. If as is likely with Covid, users are asked to disinfect the mat immediately before practice such odors or vapors may linger during the practice and be an irritant to the user or others practicing nearby.

To produce an antiviral effect for an article 100 that reduces the need for or frequency of chemical cleaning, yoga article 100 includes an effective amount of an antiviral material 125. Antiviral material may include a polymer antiviral material, such as a sulfonated copolymer, like BiaXam, ™ or other non-metal antiviral material. Antiviral material 125 may include an antiviral metal 126 such as at least one of a copper, zinc, and silver metal. Combinations or alloys of the antiviral metal with other materials may still produce an antiviral metal or metal oxide that is effective such as ZnO and TiO2. For example, an antiviral metal 126 containing copper content in the range of 0.25 to 10% by weight has been shown to be effective in damaging virus cell membranes and killing a virus contacting the antiviral metal. Greater percentages by weight of copper in such alloys has been shown to damage the cell membranes at a faster rate resulting in more rapid death of the virus. Testing of copper ion in an amount of 1% by weight has been found effective in neutralizing 95% of an HIV virus present in a sample in twenty minutes, U.S. Pat. No. 7,169,402, which is incorporated herein by reference. While it is expected that the effect on a coronavirus will be different, the presence of copper in percentages as low as 0.25% to 10% are expected to be effective in reducing the life span of the virus on a contact surface 120 from one or more days to hours or even minutes. More recent research has shown that copper content in an alloy, such as brass, on the order of 60% to 100% is effective in greatly reducing the lifespan of COVID-19. Copper content of 60% by weight neutralized COVID-19 on a contact surface to approximately two hours while increasing percentages reduced the lifespan even further with neutralization times reaching 2.5 minutes when 100% copper is used. (Michels and Michels, “Can Copper Help Fight COVID-19?”).

According to the disclosure, antiviral material is distributed within or on a contact surface 120 of yoga article 100. At least a portion of the antiviral material 125 may be exposed to promote direct content with any virus that finds its way onto the contact surface 120. Moreover, the exposure of at least a portion of the antiviral material 125 on a contact surface 120 places the antiviral material 125 in contact with the user's skin or clothing during the practice of yoga. In addition, to the antiviral effect achieved through such contact, other wellness benefits including conductivity and grounding between the user and the yoga article 100 are achieved.

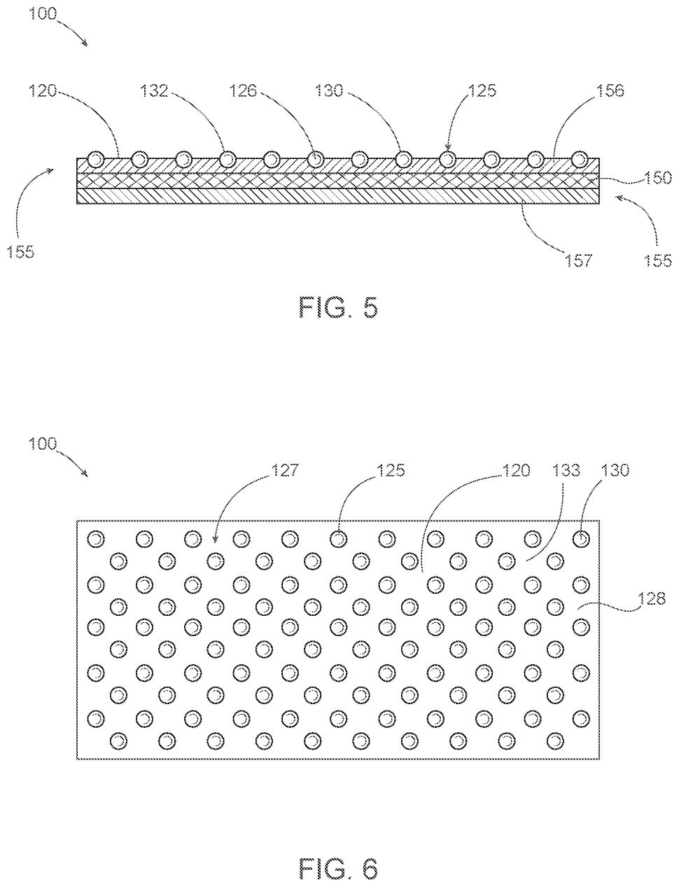

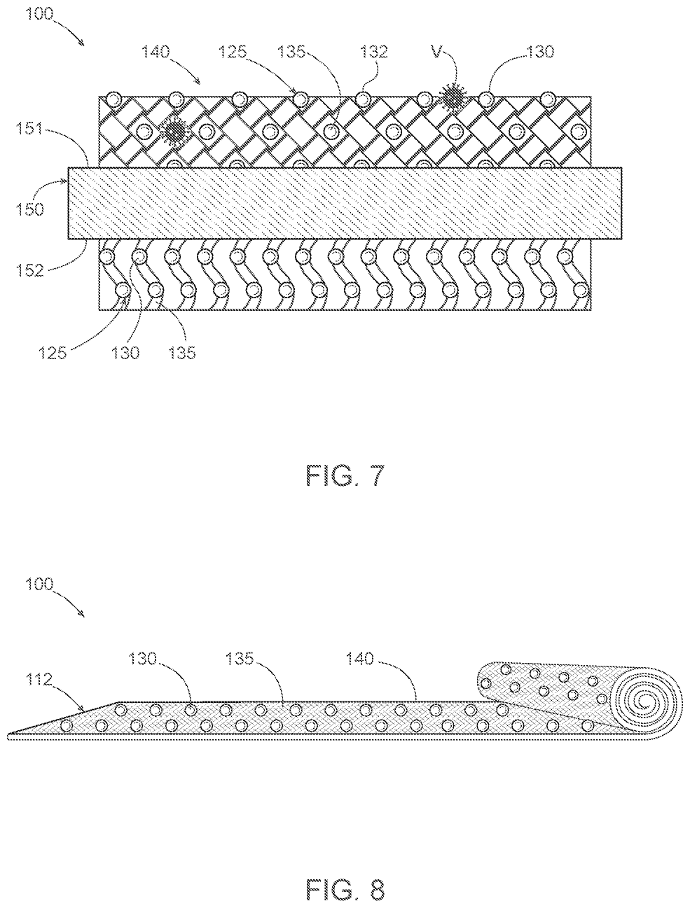

With reference to FIGS. 5 and 6, an example article 100 having an effective amount of antiviral material 125 is shown. In the example, antiviral particles 130 are distributed on a contact surface 120 in a pattern 127. The figures are schematic with the particle size and pattern 127 enlarged to facilitate visibility and are not shown to scale. As depicted in FIG. 5, particles 130 containing antiviral metal 126 may be located at or near the contact surface 120 of article 100. As shown, a portion 132 of the antiviral metal 126 may be exposed and protrude from article 100. For example, in a yoga mat 110 made of a polymer foam, a particle 130 of antiviral metal 126 may be partially embedded within the foam with an exposed portion 132 of particle 130 extending out from the surface of the foam. In other examples (FIG. 7), article 100 may include fibers 135 that have antiviral material thereon, such that the antiviral material 125 extends outward from the fiber 135 to contact the virus and or the user's skin.

As depicted in FIG. 5, article 100 may be constructed in a laminate structure having a substrate 150 with at least one outer layer 155 attached to the substrate 150. In the example, an upper layer 156 forms the contact surface 120 and is provided with the antiviral metal 126. It will be understood that the lower layer 157, shown, may likewise contain antiviral metal 126 to provide to antiviral contact surfaces 120. Similarly, antiviral metal 126 may be distributed at the margins of each layer to provide an antiviral effect at the edges of the article 100 as well.

FIG. 6 shows distribution of particles 130 of antiviral material 125 in a pattern 127 on an article 100. The pattern 127 is not limiting and any pattern of regular, irregular, or random position of antiviral material 125 across a contact surface 120 of an article 100 may be used and is limited only by the imagination of the designer. In the example shown, antiviral material 125 is distributed on article 100 in a spaced fashion, i.e. spacing or gaps 133 between the particles 130 , to provide intermittent areas of antiviral material 125 spaced from each other by a base material 128. The antiviral material 125 may have a lower coefficient of friction than the material of the yoga article 100 such that its surface is less grippy. During poses, a level of grip may be needed to support the user in maintaining a pose. The base material 128 may be selected to include a higher coefficient of friction than the antiviral material 125 to create a grippier surface for user contact. During the practice of yoga, it is common for the user to perspire onto an article 100. The presence of moisture on the antiviral material may exacerbate the slipperiness of the antiviral material 125. Therefore, a base material 128 may be selected to wick moisture away from antiviral material 125 and/or the user. For example, textile materials may be used with fibers that provide a wicking action or materials such as polymer foams having a higher wicking coefficient than the antiviral material 125 may be used to the same effect.

With reference to FIG. 7, an article 100 having an outer layer comprised of a fibrous product is shown. The fibrous product, may be napped material with outward extending fibers 135 or a woven or non-woven textile or fabric 140 formed with fibers 135. In the example, the first surface 151 is covered with a woven fabric 140 and and second surface 152 includes napped fibers 135 extending outward from core 150. As described above, the fibers 135 contain antiviral material 125 that is exposed on the surface of the fiber 135 to contact virus V on article 100. FIG. 7 is a schematic figure and antiviral material 125 is enlarged to show its presence on a fiber 135. When using a fiber, suitable particle sizes will generally be a function of the fiber thickness with the particle size generally being less than the thickness of the fiber. Particle sizes of at least 0.01 micron are believed to be suitable. For a polymer fiber typically used in the textile industry such as a polyester fiber, a range of 0.5 micron to 2 microns is suitable. It will be understood that the size of antiviral material particles interspersed within and on the fibers 135 may vary depending on the type of metal used, the type and size of the fiber, and process for forming the fibers 135. Therefore, the above examples are not limiting.

Fiber 135 may be constructed of natural materials including but not limited to cotton, silk, hemp, and the like or be manufactured from a polymer material including but not limited to polyamide, polyester, polypropylene, and other polymer materials. The Curpon® fiber is a suitable polymer fiber having antiviral metal in the form of a copper ion (Cu++) particles on the fiber. The Cupron® fiber has copper particles of at least 0.25% weight. Typical fibers contain copper particles in a range of 0.25% weight to 10% weight in the Cupron® product. As noted, these weight percentages have been shown to be effective in shortening the lifespan of a virus. Higher weight percentages ranging up to 100% copper are expected to increase effectiveness by further shortening the life span. According to examples herein, higher weight percentages can be achieved in a fiber 135 by adding higher percentages of antiviral metal during formation of the fibers.

As discussed, the disbursement of an effective amount of antiviral metal 126 on or within yoga article 100 may vary. Suitable ranges of an effective amount of antiviral metal include but are not limited to greater than 0.25% by weight; 0.25% to 10% by weight; 1% to 10% by weight; 5% to 25% by weight; 0.25% to 95% by weight; 0.25% to 90% by weight; 0.25% to 80% by weight; 0.25% to 70% by weight; 0.25% to 35% by weight; 0.25% to 45% by weight; 25% to 45% by weight; 45% to 75% by weight; and 50% to 65% by weight.

For purposes of creating an article 100 with antiviral properties, a balance between higher weight percentages of antiviral metal and the need for non-metal surfaces to provide grip, cushioning, and wicking properties is needed. As described below, while materials having 100% by weight antiviral metal may be used these materials may be provided on the contact surface in a spaced relationship or additional material that provides at least one of grip, cushioning, or wicking properties added to the contact surface in a post processing step.

With reference to FIGS. 16 and 17, article 100 may be used in other forms of physical fitness or fitness activities including but not limited to walking, running, Pilates, wrestling or weight training. To that end, article 100 may include padding used on or within equipment used in these activities such as an insert 115 for a shoe (FIG. 16) or padding 117 placed on touch surfaces of equipment 119. For example, the padding 117 used on equipment 119 may include grips 117A on portions where the user may place their hands, seats 1176, benches 117C, or pads 117D that contact other parts of the body. As in previously described examples, insert 115 or padding 117 includes an antiviral material 125 in an amount effective to produce at least an antiviral effect. Antiviral material 125 may optionally be arranged on article 100 in a pattern 127 as shown. The antiviral material 125 may have an exposed portion 132 that is present on a contact surface 120 to provide direct contact with the user's skin or clothing. Antiviral material 125 may be incorporated in particle form 130 and be present within a substrate 150 or as part of a fiber 135 used to form the article 100 or any portion thereof.

The following are non-limiting examples of processes for producing an article 100 with an effective amount of antiviral material 125. In one example process, generally indicated by the number 200, antiviral metal particles 130 are infused with a textile fiber 135. The textile fiber 135 may be a polymer fiber to which the particles 130 are attached during polymerization of the fiber such that the particle 130 is bonded to or infused with the fiber 135. One suitable fiber is the fiber manufactured by Cupron containing copper ion particles on the surface of the fiber in weight percentages of at least 0.25 to about 10% by weight. Fibers having infused copper particle content in weight percentages of greater than 10% would also be effective as described above.

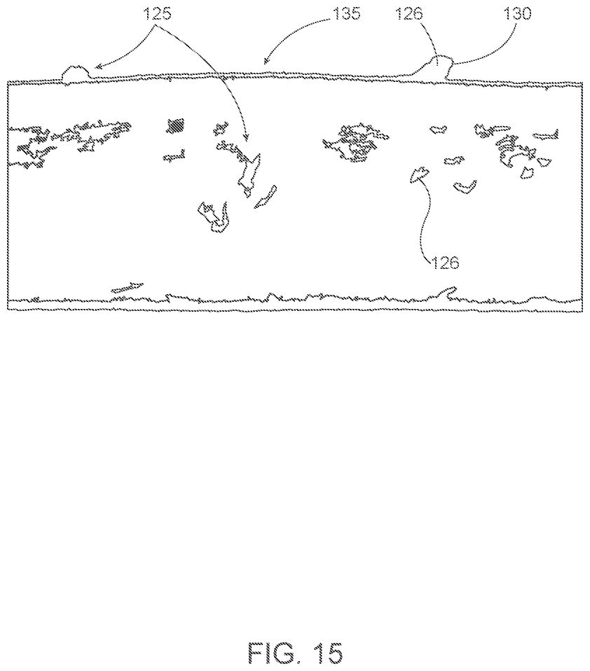

Fibers infused with antiviral metal 126, such as the Cupron® fiber, produce a metal particle 130 that projects from the fiber surface (FIG. 15). This allows at least partial exposure of the antiviral metal particle 130 when individual fibers are woven to form a fabric 140 (FIG. 7). The distribution of particles 130 of antiviral metal throughout the fibers 135 ensures a distribution of antiviral metal throughout the fabric 140.

The antiviral fabric 140 may then be used to form the contact surface(s) 120 of article 100 to ensure the effective amount of antiviral metal 126 is present for contact with the user's hands, feet, sweat, or aerosol droplets from breath containing virus V during the practice of yoga or handling of the yoga article 100. When considering a yoga mat 100, the antiviral fabric 140 may be laminated to a urethane foam substrate 150 forming an outer layer on at least one of the contact surfaces 120 of yoga mat 110.

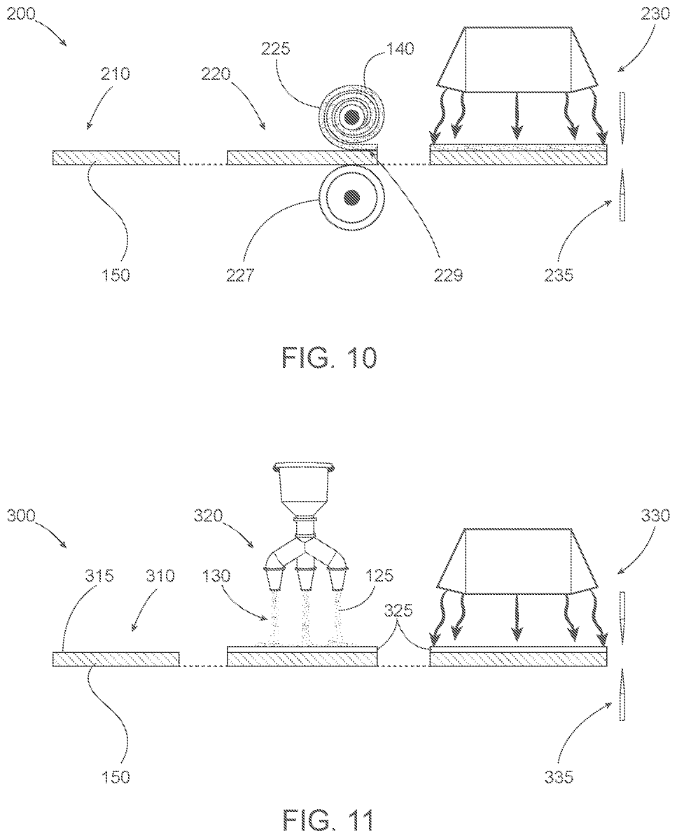

In the example process 200 shown in FIG. 10, a urethane foam substrate 150 is formed at 210. The urethane substrate 150 is uncured at step 210 to allow for adhesion of a fiber layer. A fabric 140 containing an effective amount of antiviral material 125 is applied to a first surface 151 of substrate 150 in a laminating step 220. Laminating step 220 may include any suitable laminating process to apply the fiber layer to the urethane. In the example, a roll 225 of fiber material or fabric 140 is provided opposite a roller 227 forming a nip 229. The urethane substrate 150 is fed through the nip 229 causing fabric 140 to contact the uncured urethane. The adhesion between the urethane and the fabric 140 pulls the fabric 140 from the roll 225 as the urethane is fed through the nip 229. With the fabric 140 attached, a curing step may be performed at 230 as needed. Once the urethane is covered in a fiber layer, a cutter 235 may be used to form a desired shape for the yoga article. Cutter 235 may be any cutter suitable for forming the desired shape including but not limited to a mechanical cutter, a hot wire filament, a laser cutter or the like.

According to a further example, a pair of rollers may apply two layers of fiber on opposite sides of the substrate 150. In this example, the two major surfaces of substrate 150 are provided with an effective amount of antiviral material 125.

With respect to the use of the fiber to form a fabric 140 or nap layer on yoga article 100 as depicted in the example process, the weave of fabric 140 and creation of a nap may be used to increase the grip of contact surface 120 for the practice of yoga and help wick and absorb sweat away from the user's skin. The presence of antiviral material 125 on the fibers allows the antiviral material 125 to contact not only the user's skin but the droplets of sweat or other moisture from the user and wick that moisture away from the user while acting to shorten the life span of the virus. According to one example, an antiviral metal such as a copper salt or other ionic form of copper, such as Cu++, may be used to facilitate the antiviral effect when such moisture reacts with the copper salt or ionic copper.

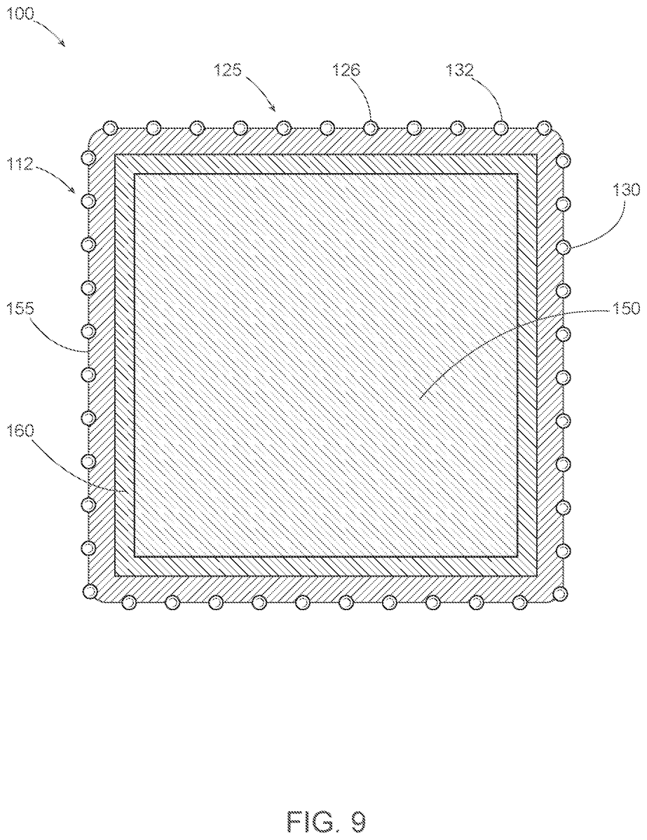

It will be understood that fabric 140 containing antiviral material 125 may be applied to surfaces of other articles 100 such as the yoga block 112, yoga strap 114, yoga blanket 116, shoe insert 115 or fitness equipment padding 117 described above. For those products, such as the yoga strap 114 and yoga blanket 116 that are typically made of textile materials, the articles may be formed directly from the textile fibers 135 as shown in FIG. 8. In the example of a yoga block 112, the block 112, like mat 110, may be formed with a substrate 150 having the desired shape and material containing particles 130 of antiviral metal 125 applied as a sheath 155 covering all of the substrate surfaces. FIG. 9 shows a yoga block 112 where substrate 150 forms a rectangular solid core. The figure depicts a portion of the article 100 cut away to depict details of the block's core 150 and a sheath 155 containing antiviral material 125, such as antiviral metal 126 provided around the core. In this example, the antiviral metal 126 is provided within a sheath 155 formed from fibers containing antiviral metal particles 130 thereon. The sheath 155, in the example, surrounds a foam substrate 150. To prevent relative movement between the substrate 150 and the sheath 155, sheath may be attached to the substrate 150. For example, sheath 155 may be laminated to substrate 150 as described above or attached with an adhesive, stitching or other fastener 160.

With reference to FIG. 11, another example process generally indicated at 300 includes applying a coating 325 containing an effective amount of antiviral material 125 to at least one contact surface 120 of an article 100. In the example shown, a urethane foam (open or closed cell) is formed at 310 to form a substrate 150. For example, forming step 310 may define a sheet 315 to form a layer of padding or a yoga mat 110. The sheet 315 may be continuously formed and cut by a cutter 335 into a desired shape as discussed in the previous example.

According to this example, antiviral material 125 is applied in a coating step at 320. Coating 325 may be applied in any suitable manner including but not limited to a gravity feed, such as dusting or dropping antiviral material additives, particles or powders onto the substrate 150, spraying a slurry containing antiviral material or jetting the material directly onto the substrate 150. In the example, one or more nozzles 320 are provided to distribute antiviral material 125 on sheet 315 to create a contact surface 120 with an effective amount of antiviral material 125 thereon. In the example, nozzles 320 are placed above sheet 315 to coat a top surface. It will be understood that nozzles 320 may be placed in other locations to apply antiviral material 125 on other surfaces of sheet 315.

Coating 325 may contain antiviral metal 126 as particles 130 as described in the previous example in solution with a polymeric material suitable for adhering to sheet 315 on contact of after a suitable curing process, generally indicated at 330. Curing 330 may include but is not limited to air curing, light curing, heat curing, sonic curing, chemical curing combinations thereof, and the like. According to the examples, particles 130 may be partially exposed within coating to provide direct contact between the antiviral material 125 and any virus that finds its way onto contact surface 120. Selection of suitable particle sizes may allow the particles to be exposed as the coating material settles after it is distributed onto the sheet 315. In some instances, the particles 130 may be partially exposed as a result of the curing step 330. In still other examples, it may be necessary to perform a further step to at least partially expose the particles including but not limited to mechanical tumbling or abrasion; ultraviolet or other light source exposure, or chemical washing to remove a portion of any polymer covering an outer surface of the antiviral material 125.

A cutter 335 may be used at any step in the process to cut the ultimate shape of article 100 from sheet 315. In the example shown, cutter 335 cuts sheet 315 into a yoga mat shape with a simple pinch cut across the width of the sheet 315. As described above in the prior example, any suitable cutter 335 may be used and any desired shape may be cut to form the desired yoga article 100.

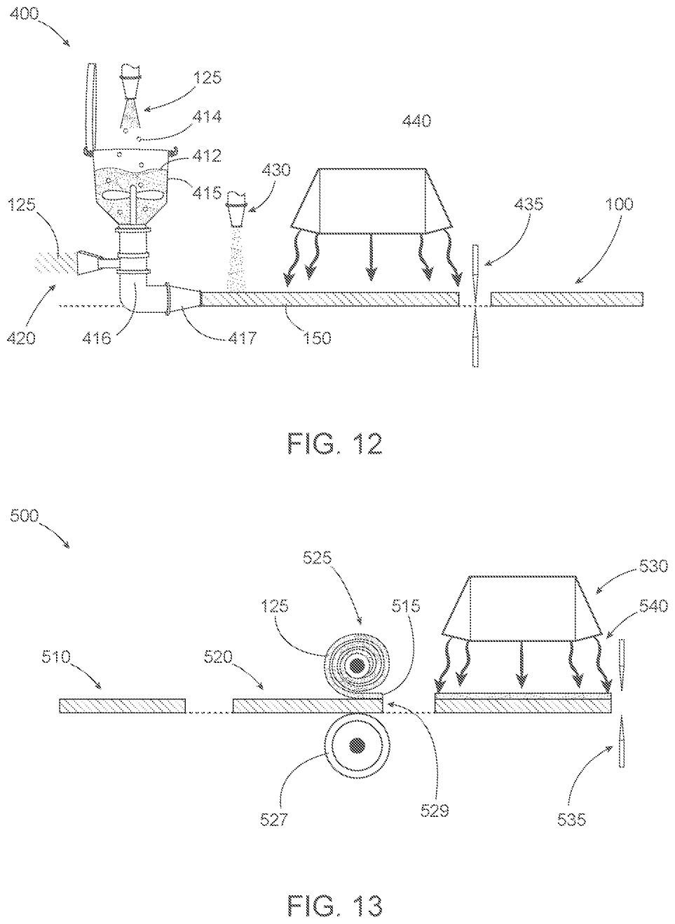

In another example process generally indicated by the number 400 in FIG. 12, antiviral material 125 is mixed within the polymer material forming the article 100. For example, antiviral material 125 may be added to a polymer component 412 during the process of forming the article 100 or a pre-made polymer component 414 containing an effective amount of antiviral material 125 may be used during the polymerization process to form article 100.

In a yoga mat example as described above, a urethane foam (open or closed cell) may be used to form the yoga mat 110. During polymerization of the urethane foam, antiviral material 125 may be added at step 410. As described, the addition step 410 may include adding antiviral material 125 directly to a polymer component 412 or adding a pre-made polymer component 414 for use in polymerization. In one example, a polymer additive such as a sulfonated copolymer, like BiaXam™ by Kraton, was shown effective as a polymer additive that creates an antiviral effect on Covid.

As depicted, a nozzle 415 may be used to perform the addition step 410 delivering the antiviral material 125 in raw form or in a pre-made polymer component 414 to a container 415 where polymerization occurs. Using urethane foam production as an example, container 415 initially contains liquid polymer components 414, such as a mixture of polyol and diisocyanate. Other polymer components may be used and catalysts may be added to vary the property of the material based on its ultimate application. In the example, an antiviral material 125 is mixed with the polymer components 414. The material may be sifted, poured or otherwise delivered to the polymer component 414. To facilitate mixing, an agitator may be used. In one example, an antiviral metal 126, such as copper powder, is added to mixing container 415 with the other polymer components used to form a polyurethane foam. An effective amount of antiviral metal is added on a weight percentage basis as noted in the examples above. According to the example shown, copper oxide powder in a weight percentage greater than 0.25% is added, and in particular examples, 1%-3% by weight of copper powder was added. In the example, the particle size for the copper oxide was about 1 micron. Mixing of the polymer components and copper begins the polymerization reaction. Once mixed, reacting materials may be passed through a heat exchanger 416 to adjust the temperature for reaction and the resulting polyurethane foam may be pumped or gravity fed to a mold head 417 to form the article shape and prepare the foam for further processing. In the example, the mold head 417 has a rectangular opening that produces a thin sheet suitable for use as a yoga mat, yoga strap or yoga blanket.

Alternatively, antiviral material 125 may be added as the foam is formed, as schematically depicted at 420, or after the foam is formed but before it has cured as schematically depicted at 430. Post processing steps including curing 440 and cutting 435 as described in other examples may be incorporated to form yoga article 100 according to this example.

In another example process generally indicated by the number 500 in FIG. 13, an effective amount of antiviral material 125 is incorporated into an article 100 by laminating an antiviral matrix 515 as part of the article 100. Antiviral matrix 515 contains an effective amount of antiviral material 125. The antiviral matrix 515 may include screen, mesh, woven or non-woven mat, film or other planar structures formed at least partially from the antiviral material 125. According to one example, the antiviral matrix 515 may formed from a fiber containing antiviral material 125 thereon that is formed in a screen, mesh, woven or non-woven mat or other planar structure to provide antiviral material 125 in a form that may be laminated onto the article. The fiber carrying the antiviral material 125 may be a sacrificial fiber that falls away from antiviral material 125 during bonding or curing of the matrix to form the article or during a post processing step.

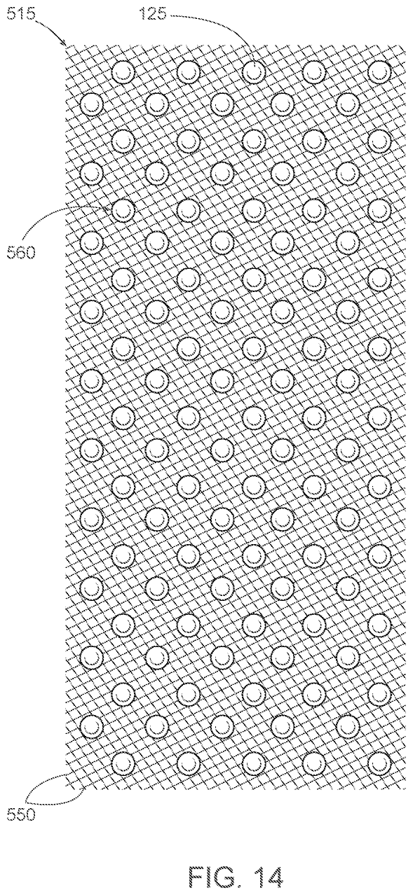

One example of an antiviral matrix is schematically shown in FIG. 14. As depicted matrix 515 may include antiviral material 125 carried on or formed with a matrix member 550. The matrix members may be placed in a spaced relationship relative to each other to define voids 555 therebetween. As shown, matrix members 550 may be arranged in crossing parallel lines to form a rectangular screen like arrangement with square voids 550 therebetween. The voids 555 allow the substrate material to pass through the matrix 515 facilitating attachment of the matrix layer to the substrate 150 and providing exposed portions of the substrate material that having a higher coefficient of friction than the antiviral material. This patterning of metal and non-metal on the contact surface 120 of article 100 provides grip needed during yoga practice. As shown, matrix member 550 from a laminar structure that facilitates the lamination process and may be used to more evenly distribute antiviral material 125 across a surface. It will be understood that the matrix members may be arranged in any desired pattern and with any desired density between members and voids to provide the desired pattern of antiviral material 125. Moreover, as shown, antiviral material 125 may be carried on matrix members 550 in a desired pattern 560 or a random arrangement may be formed.

In the example shown in FIG. 14, matrix members 550 include filaments formed in a screen-like form, where the antiviral material 125 is carried on the filaments. It will be understood that the filaments may be constructed of a sacrificial material that dissolves within the urethane upon contact, during curing, or during a post processing step such as a wash or the like. To that end, matrix member 550 may include a film, screen, mesh or other supporting structure made of a sacrificial material. In this way, the matrix members may be removed to leave the antiviral material 125.

In the example shown in FIG. 13, a urethane substrate is provided at step 510. A lamination step 520 includes applying the antiviral matrix 515. In the example, a roll 525 of antiviral matrix material is provided opposite a roller 527 to form a nip 529 through which the urethane substrate moves. The urethane substrate may be left uncured at least on the surface to which the matrix 515 is being applied to facilitate attachment. In the example shown, the uncured upper surface of the urethane is tacky such that contact with the roll of material within the nip 529 adheres the end of the antiviral matrix 515 to the urethane and unrolls it from the roll 525 as the urethane moves through the nip 529. A cutter 535 may be used to cut the matrix 525 at the end of the article 100. After the matrix 525 is applied, the article may be cured at step 530. The curing step 530 may include suitable curing to cure the urethane substrate and adhere the antiviral matrix 525. For example, air curing, light curing, heat curing, sonic curing, chemical curing combinations thereof, and the like. generally indicated at 540, may be used.

As depicted, these planar structures may be incorporated within the article 100 to provide antiviral material 125 at a contact surface 120 thereof. In the example shown, a urethane foam is formed in a sheet like structure and the antiviral matrix 515 is laminated on at least one surface of the sheet. Lamination of the matrix 515 may occur prior to a curing step to provide direct adhesion to the urethane foam. According to one example, a screen constructed of an antiviral metal such as copper is laminated within a urethane foam to form an article 100. An open cell urethane foam is used to expose at least a portion of the antiviral metal at a contact surface 120 of article 100.

It will be understood that any of the above methods may be used in combination to form an antiviral article 100. For example, a polymer material may be infused with antiviral metal 126 as described in process 400 by mixing metal particles or powder within a polymer solution to form a polymer substrate, and an antiviral fiber 135 or fabric 140 may be incorporated with or attached to the substrate 150 as described in process 200. The same substrate from process 400 may be coated as described in process 300. Likewise, the substrate formed by process 400 may also incorporate an antiviral matrix 515 by incorporating process 500.

The words used in the claims have their full ordinary meaning and are not limited in any way by the description of the embodiments in the specification. Further, as described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

### EXAMPLES

Example 1. An article used in the practice of yoga that may be exposed to a virus, the article including a substrate having at least one contact surface, wherein the substrate includes an antiviral metal in an effective amount to reduce the life span of the virus, wherein the antiviral metal is at least partially exposed on the contact surface of the substrate.

Example 2. An article used in the practice of yoga that may be exposed to a virus, the article including a substrate having at least one contact surface, the substrate including at least one of a film containing antiviral metal, a coating containing antiviral metal, and a fiber having antiviral metal thereon attached to at least one contact surface such that at least a portion of the antiviral metal is exposed; wherein the antiviral metal includes at least one of a copper, a zinc, a silver and ionic forms thereof; the substrate containing an effective amount of antiviral metal to reduce the lifespan of the virus on the contact surface.

Example 3. A process for producing a yoga article according to the above examples comprising providing a substrate, adding an effective amount of antiviral metal to the substrate; and forming the substrate containing the effective amount of antiviral metal into a yoga article.

Example 4 .The process of example 3, wherein the forming step includes forming the substrate into a sheet and cutting the sheet into at least one of a yoga mat, yoga blanket and a yoga strap.

Example 5. The process of example 3, wherein the forming step includes molding the substrate into a yoga block.

Example 6. The process of example 3, wherein the step of adding includes laminating a fabric constructed from fibers having the antiviral metal theron to the substrate

Example 7. The process of example 3, wherein the step of adding includes depositing an antiviral metal powder on a contact surface of the substrate and subsequently curing the substrate with the antiviral metal thereon.

Example 8. The process of example 3, wherein the step of adding includes spraying a coating containing antiviral metal therein on a surface of the substrate.

Example 9. The process of example 3, wherein the step of adding includes forming an antiviral matrix including matrix members having an antiviral metal thereon, and laminating the antiviral matrix to the substrate

Example 10. An article used in a fitness activity that may be exposed to a virus, the article including a substrate having at least one contact surface, wherein the substrate includes an antiviral metal in an effective amount to reduce the life span of the virus, wherein the antiviral metal is at least partially exposed on the at least one contact surface of the substrate.

Example 11. The article of example 10, wherein the effective amount of antiviral metal includes at least 0.25% by weight.

Example 12. The article of example 10, wherein the effective amount of antiviral metal is from 0.25% to 10% by weight.

Example 13. The article of example 10, wherein the effective amount of antiviral metal is from 0.25% to 95% by weight.

Example 14. The article of example 10, wherein the effective amount of antiviral metal is from 50% to 65% by weight.

Example 15. The article of example 10, further comprising an antiviral matrix joined with the substrate, the antiviral matrix supporting the antiviral metal thereon and positioning it such that the antiviral metal is at least partially exposed on the at least one contact surface.

Example 16. The article of example 10, wherein the antiviral metal is distributed in a pattern on the contact surface of the substrate.

Example 17. The article of example 10, wherein the antiviral metal is applied on a contact surface in a pattern defining a gap between the antiviral metal, where the gap includes a base material having a higher coefficient of friction relative to the antiviral metal.

Example 18. The article of example 10, wherein the antiviral metal is ionic copper.

Example 19. An article used in a fitness activity that may be exposed to a virus, the article including a substrate having at least one contact surface, wherein the substrate includes an antiviral material within the at least one contact surface in an effective amount to reduce the life span of the virus contacting the at least one contact surface.

Example 20. The article of example 19, wherein the substrate is formed into a fitness article selected from the group consisting of a yoga mat, a yoga block, a yoga blanket, a yoga strap, a shoe insert, and a padded surface on a piece of fitness equipment.

Example 21. The article of example 19 wherein the antiviral material is BiaXam.

Example 22. The article of example 19, wherein the antiviral material is an antiviral metal.

Example 23. The article of example 22, wherein the antiviral metal is ionic copper.

Example 24. The article of example 19, wherein the antiviral material is a Cupron fiber.

Example 25. An antiviral article used in a fitness activity, where the article may be exposed to a virus, the article comprising: a substrate having at least one contact surface, the substrate including at least one of a film containing antiviral metal, a coating containing antiviral metal, and a fiber having antiviral metal thereon attached to the at least one contact surface, wherein at least a portion of the antiviral metal is exposed on the at least one contact surface; wherein the antiviral metal includes at least one of a copper, a zinc, a silver and ionic forms thereof; and the substrate containing an effective amount of antiviral metal to reduce the lifespan of the virus contacting the at least one contact surface.

Example 26. A method of making an antiviral article comprising the steps of: forming a substrate having at least one contact surface; adding an antiviral material with the substrate such that the antiviral material is at least partially exposed on the at least one contact surface.

Example 27. The method of example 26, wherein the step of adding includes providing a BiaXam additive to a polymer material forming the substrate.

Example 28. The method of example 26, wherein the antiviral material is an antiviral metal.

Example 29. The process of example 26, wherein the forming step includes forming the substrate into a sheet and cutting the sheet into at least one of a padding, a yoga mat, yoga blanket and a yoga strap.

Example 30. The process of example 26, wherein the forming step includes molding the substrate into at least one of a shoe insert, a grip, a pad, and a yoga block.

Example 31. The process of example 26, wherein the step of adding includes attaching a fabric constructed from fibers having the antiviral metal thereon to the substrate

Example 32. The process of example 26, wherein the step of adding includes depositing an antiviral metal powder on at least one contact surface of the substrate and subsequently curing the substrate with the antiviral metal thereon.

Example 33. The process of example 26, wherein the step of adding includes spraying a coating containing antiviral material therein on a surface of the substrate.

Example 34. The process of example 26, wherein the step of adding includes forming an antiviral matrix including at least one matrix member having an antiviral material thereon, and laminating the antiviral matrix to the substrate.

Specific examples of an innovation are disclosed herein, but these examples are not limiting. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the subject innovation has been shown and described with respect to a certain preferred embodiment or embodiments, equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. As used herein, spatially orienting terms such as “above,” “below,” “upper,” “lower,” “inner,” “outer,” “right,” “left,” “vertical,” “horizontal,” “top,” “bottom,” “upward,” “downward,” “laterally,” “upstanding,” et cetera, can refer to respective positions of aspects as shown in or according to the orientation of the accompanying drawings. “Inward” is intended to be a direction generally toward the center of an object from a point remote to the object, and “outward” is intended to be a direction generally away from an internal point in the object toward a point remote to the object. Such terms are employed for purposes of clarity in describing the drawings, and should not be construed as exclusive, exhaustive, or otherwise limiting with regard to position, orientation, perspective, configuration, and so forth.

Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements. For an understanding of the scope of the invention, reference is made to the following claims.

1. An article used in a fitness activity that may be exposed to a virus, the article including a substrate having at least one contact surface, wherein the substrate includes an antiviral metal in an effective amount to reduce the life span of the virus, wherein the antiviral metal is at least partially exposed on the at least one contact surface of the substrate.

2. The article of claim 1, wherein the effective amount of antiviral metal includes at least 0.25% by weight.

3. The article of claim 1, wherein the effective amount of antiviral metal is from 0.25% to 10% by weight.

4. The article of claim 1, wherein the effective amount of antiviral metal is from 0.25% to 95% by weight.

5. The article of claim 1, wherein the effective amount of antiviral metal is from 50% to 65% by weight.

6. The article of claim 1, further comprising an antiviral matrix joined with the substrate, the antiviral matrix supporting the antiviral metal thereon and positioning it such that the antiviral metal is at least partially exposed on the at least one contact surface.

7. The article of claim 1, wherein the antiviral metal is applied on a contact surface in a pattern defining a gap between the antiviral metal, where the gap includes a base material having a higher coefficient of friction relative to the antiviral metal.

8. The article of claim 1, wherein the antiviral metal is copper.

9. The article of claim 1, wherein the antiviral metal is Cu++

10. The article of claim 1, wherein the antiviral metal is provided in a particle having a size of at least 0.01 micron.

11. The article of claim 10, wherein the particle has a size between 0.5 micron to 2 microns.

12. An article used in a fitness activity that may be exposed to a virus, the article including a substrate having at least one contact surface, wherein the substrate includes an antiviral material within the at least one contact surface in an effective amount to reduce the life span of the virus contacting the at least one contact surface.

13. The article of claim 12, wherein the substrate is formed into a fitness article selected from the group consisting of a yoga mat, a yoga block, a yoga blanket, a yoga strap, a shoe insert, and a padded surface on a piece of fitness equipment.

14. The article of claim 12 wherein the antiviral material is BiaXam.

15. The article of claim 12, wherein the antiviral material is ionic copper.

16. The article of claim 12, wherein the antiviral material is a Cupron fiber.

17. An antiviral article used in a fitness activity, where the article may be exposed to a virus, the article comprising:
a substrate having at least one contact surface,
the substrate including at least one of a film containing an antiviral metal, a coating containing the antiviral metal, a matrix supporting the antiviral metal, and a fiber having the antiviral metal thereon attached to the at least one contact surface, wherein at least a portion of the antiviral metal is exposed on the at least one contact surface;
wherein the antiviral metal includes at least one of a copper, a zinc, a silver and ionic forms thereof; and
the substrate containing an effective amount of antiviral metal to reduce the lifespan of the virus contacting the at least one contact surface.

18. The antiviral article of claim 17 wherein the antiviral metal includes a particle having a size of at least 0.01 micron.

19. The antiviral article of claim 17, wherein the effective amount of antiviral metal includes at least 0.25% by weight.

20. (canceled)
